(19) United States
(12) Patent Application Publication
(10) Pub. No.: US 2013/0314719 A1
(43) Pub. Date: Nov. 28, 2013

(54) Substrate Detection Apparatus

(71) Applicant: Daifuku Co., Ltd., (US)

(72) Inventors: Takahiro Horii, Gamo-gun (JP); Takamichi Kanno, Gamo-gun (JP)

(73) Assignee: Daifuku Co., Ltd., Osaka-shi (JP)

(21) Appl. No.: 13/891,594

(22) Filed: May 10, 2013

(30) Foreign Application Priority Data
May 11, 2012 (JP) 2012-109793

(51) Int. Cl. G01V 8/10

(52) U.S. Cl. CPC G01V 8/10
USPC 356/614

(57) ABSTRACT

A substrate detection apparatus has a simple structure and is easy to install. An inspection location is defined at an end of a moving range of a container as it is transported by a transport device. A range finder is provided which emits detection wave and receives the detection wave that is reflected from an object to detect the distance to the object, is located outwardly of the end of the moving range in the transporting direction, and is positioned such that the detection wave is emitted toward an opening of the container located at the inspection location and can advance through a substrate storing area in a direction that intersects with a direction parallel to the surface of the substrate. A presence determination portion is provided which determines that a substrate exists in the container if and when the detected value from the range finder falls within a predetermined range.

### FIELD OF THE INVENTION

The present invention relates to a substrate detection apparatus for detecting a substrate within a container having a substrate storing area that can store a plurality of substrates in spaced-apart layers.

### BACKGROUND

An example of substrate detection apparatus, such as one described above, for detecting the presence of substrates in a container is disclosed in JP Publication of Application No. H6-135506 (Patent Document 1). The substrate detection apparatus disclosed in Patent Document 1 includes a pair of transmission type presence sensors (with each sensor including a light emitter and a light receiver) for detecting the presence of substrates by emitting detection light along the horizontal direction which is parallel to the surfaces of the substrates with the sensors located in the front and the back of the container when the container is placed on a table such that the substrate layering direction (i.e., direction in which the substrates are layered and spaced apart from each other) of the substrate storing area is along the vertical direction. And the presence of the substrates in the container is detected by vertically moving the pair of presence sensors with respect to the container by means of a vertically moving drive mechanism over the entire vertical width of the substrate storing area.

However, with the substrate detection apparatus of the Patent Document 1, because the pair of presence sensors are vertically moved relative to the container, it takes time to detect the presence of the substrates in the container. And it is necessary to provide the vertically moving drive mechanism for vertically moving the pair of presence sensors relative to the container, which makes the structure of the substrate detection apparatus more complex.

Incidentally, when supporting and transporting a container with a transport device, the container may be transported horizontally in a transporting attitude such that the substrate layering direction of the substrate storing area has a component in the transporting direction because of a consideration regarding, for example, the attitude in which the container is stored in an article storage rack. And the presence of the substrates in the container that is transported with a transport device in this fashion may need to be detected.

In such a case, when detecting the presence of the substrates in a container with transmission type presence sensors as in the detector in Patent Document 1, one of the pair of presence sensors would have to be located on the downstream side in the transporting direction with respect to the container so that it is necessary to position the presence sensor such that it would not interfere with the container that is being transported, which makes it difficult to install the presence sensor at an appropriate location.

In addition, when providing, as a reflection type presence sensor, a pair of presence sensors with one light emitter and the other light receiver, or alternatively one presence sensor which functions both as a light emitter and a light receiver, on the upstream side in transporting direction with respect to the container, then it is unnecessary to provide a presence sensor on the downstream side in the transporting direction with respect to the container, which makes it easier to install the presence sensor. However, in order to prevent incorrectly detecting the container as a substrate by detecting the detection wave reflected by the container, an opening needs to be formed in the container to allow the detection light to go into the container. In addition, it is necessary to provide the presence sensor such that the detection light travels inside the container.

### SUMMARY OF THE INVENTION

In view of the state of art described above, a substrate detection apparatus, that has a simple structure with few constraints for the positions for installing a detecting portion, is desired.

A substrate detection apparatus in accordance with the present invention, for detecting a substrate within a container having a substrate storing area that can store a plurality of substrates in spaced-apart layers, comprises:

a detecting portion whose detection state changes depending on whether a substrate is present when a detection wave is emitted toward an opening formed in the container;

a transport device which supports and horizontally transports the container in a transporting attitude in which a substrate layering direction of the substrate storing area has a component in a transporting direction;

a presence determination portion which determines whether a substrate exists in the container;

wherein the detecting portion includes a range finder which receives the detection wave reflected by an object to detect a distance to the object,

wherein an inspection location is defined at an end of a moving range of the container as the container is transported by the transport device,

wherein the range finder is located outwardly of the end of the moving range in the transporting direction, and is configured to emit the detection wave toward the opening of the container located at the inspection location such that the detection wave advances through the substrate storing area in a direction that intersects with a direction that is parallel to a surface of a substrate; and

wherein the presence determination portion determines that a substrate exists in the container if and when a detected value from the range finder falls within a predetermined range defined as a range of distances to the substrates stored in the container located in the inspection location.

With the above-described arrangement, the range finder which detects the distance to an object is configured to emit a detection wave toward the opening of the container located at the inspection location such that the detection wave advances through the substrate storing area in a direction that intersects with a direction that is parallel to a surface of a substrate. Thus, the detected value obtained from the range finder when a substrate is stored in the container is different from the detected value obtained when no substrate is stored in the container. And the presence of a substrate in the container can be detected by virtue of the fact that the presence determination portion is configured to determine that a substrate exists in the container if and when a detected value from the range finder falls within a predetermined range defined as a range of distances to the substrates stored in the container located in the inspection location.

And the detecting portion consists of one range finder; thus, when installing the detection portion, the range finder only needs to be located outwardly of the inspection location defined at the end of the moving range, in the transporting direction. And there is no need to provide a detecting portion inwardly of the inspection location in the transporting direction. Thus, the range finder does not need to be moved relative to the container, which simplifies the structure of the substrate detection apparatus. In addition, it is not necessary to position the detecting portion so as to avoid interfering with the container transported by the transport device, which leads to less number of constraints for installation of the detecting portion.

Examples of preferable embodiments of the present invention are described next.

In an embodiment of the substrate detection apparatus in accordance with the present invention, the range finder is preferably positioned such that the detection wave is emitted in a direction that is tilted with respect to the substrate layering direction.

With the above-described arrangement, by positioning the range finder such that the detection wave is emitted in a direction that is tilted with respect to the substrate layering direction, when an object other than a substrate, such as an inner surface of the container, is located near the substrate storing area in the substrate layering direction, the distance along the emitting direction between the substrate storing area and the other object is increased compared with the case where the detection light is emitted in the direction that is parallel to the substrate layering direction. This arrangement increases the difference between the detected value obtained from the range finder when a substrate is stored in the container and the detected value obtained when no substrate is stored in the container. Therefore, the determination that the substrate exists in the container by means of the presence determination portion can be made accurately.

In an embodiment of the substrate detection apparatus in accordance with the present invention, the transporting attitude is preferably a tilted attitude in which lower portions of the substrates stored in the container are displaced more toward the end in the transport direction.

With the above-described arrangement, by configuring the transport device to transport the container in the tilted attitude in which lower portions of the substrates stored in the container are displaced more toward the end in the transport direction, the distance in the emitting direction between the substrate storing area and the other object is increased further compared with the case where the transport device supports and transports the container in the vertical attitude in which the substrates are arranged along the vertical direction. Therefore, the determination that the substrate exists in the container by means of the presence determination portion can be made more accurately.

In an embodiment of the substrate detection apparatus in accordance with the present invention, the substrates are preferably semiconductor wafers, and the range finder is preferably a laser range finder which emits laser light and receives laser light that is reflected by an object to detect the distance to the object.

With the above-described arrangement, because the range finder is a laser range finder which has high coherence, the range finder is not susceptible to the surface color, pattern, or gloss of the semiconductor wafers, which facilitates proper distance measurements to the semiconductor wafers.

### BRIEF DESCRIPTION OF THE DRAWINGS

FIG. 1 is a partially cut-out side view of a substrate storage facility,

FIG. 2 is a perspective view of substrate detection apparatus,

FIG. 3 is a side view showing laser light being emitted,

FIG. 4 is another side view showing laser light being emitted,

FIG. 5 is yet another side view showing laser light being emitted,

FIG. 6 is a control block diagram, and

FIG. 7 is a flow chart.

### DETAILED DESCRIPTION

An embodiment of substrate detection apparatus of the present invention in which the substrate detection apparatus is used in a substrate storage facility is described next with reference to the drawings.

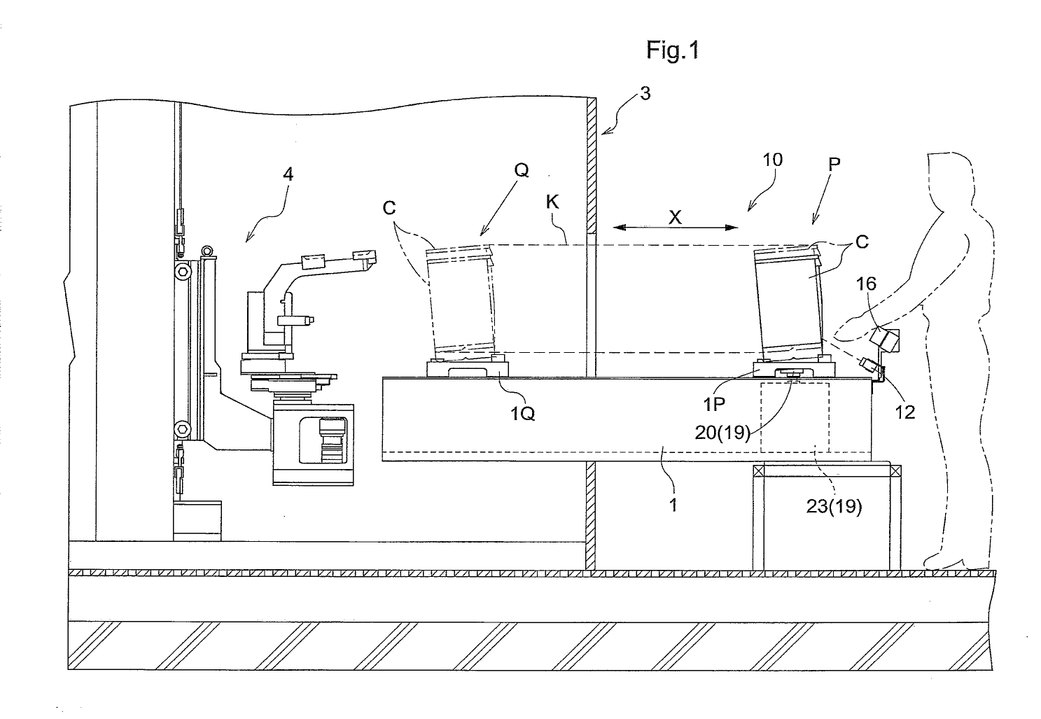

As shown in FIG. 1, the substrate storage facility includes a stocker 3 which stores containers C for housing, storing, or carrying, substrates, and a transport device 1 which supports and transports the containers C, one at a time, between the interior and the exterior of the stocker 3. Note that the substrate storage facility is installed in a clean room, and that the containers C in which substrates W are stored are stored in the stocker 3.

And when storing a container C in the stocker 3, a human worker places the container C at the operator's transfer location P in the transport device 1. The container C is then supported and transported by the transport device 1 from the operator's transfer location P to a transfer location (in-stocker transfer location) Q within the stocker 3. The container C located at the in-stocker transfer location Q is then stored in one of the storage sections (not shown) of the stocker 3 by means of an in-storage transfer device 4.

In addition, when retrieving a container C from the stocker 3, the container C stored in one of the storage sections is retrieved to the in-stocker transfer location Q by means of the in-storage transfer device 4, and is then supported and transported by the transport device 1 from the in-stocker transfer location Q to the operator's transfer location P. And the worker then unloads the container C located at the operator's transfer location P from the transport device 1.

Note that the operator's transfer location P is defined at a location located in the transporting path of the transport device 1 and in the exterior of the stocker 3. And the in-stocker transfer location Q is defined at a location located in the transporting path of the transport device 1 and in the interior of the stocker 3.

### [Container]

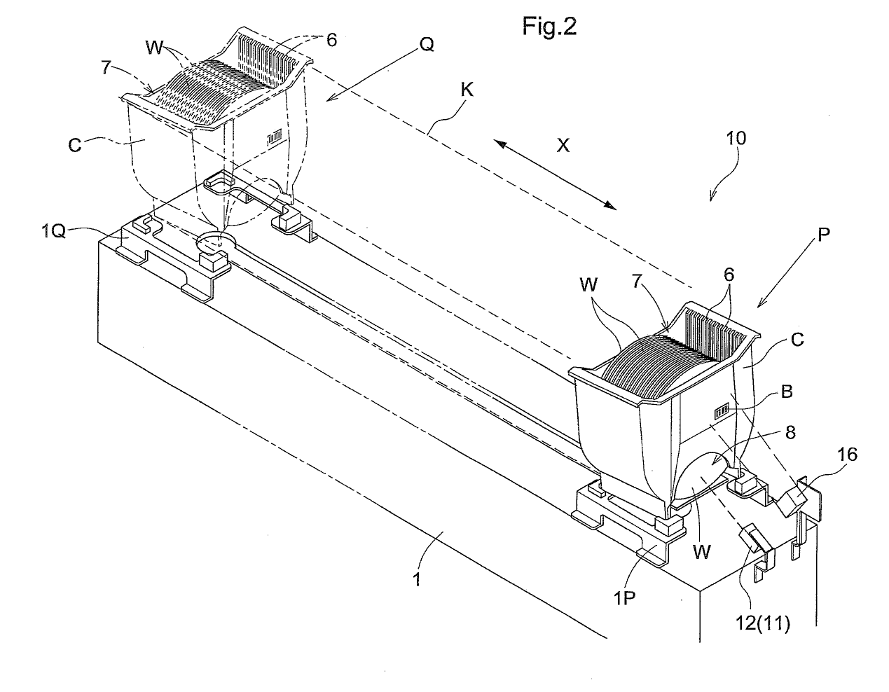

As shown in FIGS. 2-5, slits 6 for holding disk-shaped substrates W, which are semiconductor wafers, with each slit 6 configured to hold one substrate W, are formed along the vertical direction in each container C. And the plurality of the slits 6 are formed such that they are spaced apart from each other in the horizontal direction. And an access opening 7 is formed in an upper portion of the container C for taking the substrates W in and out of the container C.

The container C is configured such that substrates W can be inserted in a vertical attitude through the access opening 7 and into the slits 6 from above and such that, with the substrates W held by respective slits 6, a plurality of substrates W can be stored in a substrate storing area S of the container C such that the substrates W are arranged in spaced-apart layers in the fore and aft direction of the container 3 (container fore and aft direction). Note that the container fore and aft direction is the same direction as the substrate layering direction in which the substrates W are layered and spaced apart from each other, or arranged in space-apart layers.

In addition, an opening 8 is formed in the lower portion of the container C so that air can flow, or move, in the vertical direction within the container C. This opening 8 is formed such that it overlaps with a part of a stored substrate W when seen along the container fore and aft direction, and such that a lower end portion of a substrate W is visible when seen along the container fore and aft direction. A bar code B for indicating information specific to the container C is attached to the front face of the container C. And the container C is an open cassette in which the access opening 7 and the opening 8 are always open.

### [Transport Device]

The transport device 1 includes an inspection support platform 1P for receiving and supporting a container C located at the operator's transfer location P, an in-stocker support platform 1Q for receiving and supporting a container C located at the in-stocker transfer location Q, and a transport carriage 19 for supporting and transporting a container C between the operator's transfer location P and the in-stocker transfer location Q.

The transport carriage 19 includes a travel member 23 which can travel along a horizontal direction, and a support platform 20 supported by the travel member 23 such that the support platform 20 can be moved vertically.

Incidentally, the transporting direction is the direction along which the container C is transported by the transport device 1, more specifically, along which the container C is moved by the movement of the travel member 23, and is shown by the arrow X in FIGS. 1 and 2. In addition, the upstream side and the downstream side in the transporting direction are defined with respect to the transporting direction of the container C when storing the container C in the stocker 3, so that the side on which the operator's transfer location P is located (right-hand side in FIG. 1) is defined to be the upstream side whereas the side on which the in-stocker transfer location Q is located (left-hand side in FIG. 1) is defined to be the downstream side.

And the operator's transfer location P is defined at the upstream side end of the moving range K of the container C as it is transported by the transport device 1, and the in-stocker transfer location Q is defined at the downstream end of the moving range K of the container C as it is transported by the transport device 1. The upstream side end is an end of the moving range of the containers in accordance with the present invention.

When transporting the container C from the operator's transfer location P to the in-stocker transfer location Q, the transport device 1 is configured to lift the container C from the inspection support platform 1P by raising the support platform 20 when the travel member 23 is located directly under the container C located at the operator's transfer location P. Subsequently, the travel member 23 is caused to move to a location directly under the in-stocker transfer location Q to move the container C along the transporting direction. The support platform 20 is then lowered to lower the container C down to the in-stocker support platform 1Q, which completes the transporting of the container C.

In addition, when transporting the container C from the in-stocker transfer location Q to the operator's transfer location P, the container C is transported by operating the transport device 1 in the reverse order from when the container C is transported from the operator's transfer location P to the in-stocker transfer location Q.

Each of the inspection support platform 1P, the in-stocker support platform 1Q, and the support platform 20 of the transport device 1 is configured to receive and support the container C in a transporting attitude, or orientation, in which the substrate layering direction of the substrate storing area S has a component in the transport direction (for example, a transporting attitude in which the substrate layering direction of the substrate storing area S is along the transporting direction). Thus, the container C transported by the transport device 1 is in a transporting attitude in which the substrate layering direction of the substrate storing area S has a component in the transporting direction. And the transport device 1 is configured to support and transport the container C along the transporting direction in the transporting attitude.

In addition, each of the inspection support platform 1P, the in-stocker support platform 1Q, and the support platform 20 of the transport device 1 is configured to receive and support the container C in an tilted attitude in which the lower portions of the substrates W stored in the container C are displaced more toward the upstream side in the transport direction. In other words, the transport device 1 is configured to support and transport the container C in a tilted attitude.

In addition, as shown in FIGS. 1 and 2, the area through which the container C passes, or travels, when it is transported by the transport device 1 is defined to be the moving range K.

### [Substrate Detection Apparatus]

The substrate storage facility is provided with substrate detection apparatus 10. In addition, the substrate detection apparatus 10 includes a detecting portion 11 whose detection state changes depending on whether a substrate W is present when detection wave is emitted toward the opening 8 formed in the container C.

And the upstream side end of the moving range K is defined to be the inspection location at which the presence of the substrates W is detected by the substrate detection apparatus 10 so that the operator's transfer location P is the inspection location. The substrate storage facility includes the transport device 1, the detecting portion 11 (range finder 12), and the presence determination portion h described below.

The detecting portion 11 is a laser range finder 12 (i.e., a distance sensor) which emits laser light toward the opening 8 formed in the container C and receives the laser light reflected by an object to detect, or determines, the distance to the object.

The range finder 12 is located upstream of the upstream end of the moving range K and positioned such that it emits laser light toward the opening 8 of the container C located at the upstream side end of the moving range K, and such that the emitted laser light advances in the substrate storing area S in a direction that crosses, or intersects with, the direction along, or parallel to, the surface of the substrate W.

In addition, the range finder 12 is so positioned that it emits laser light at an upward angle toward the downstream side in the transporting direction and at an angle that is tilted with respect to the substrate layering direction.

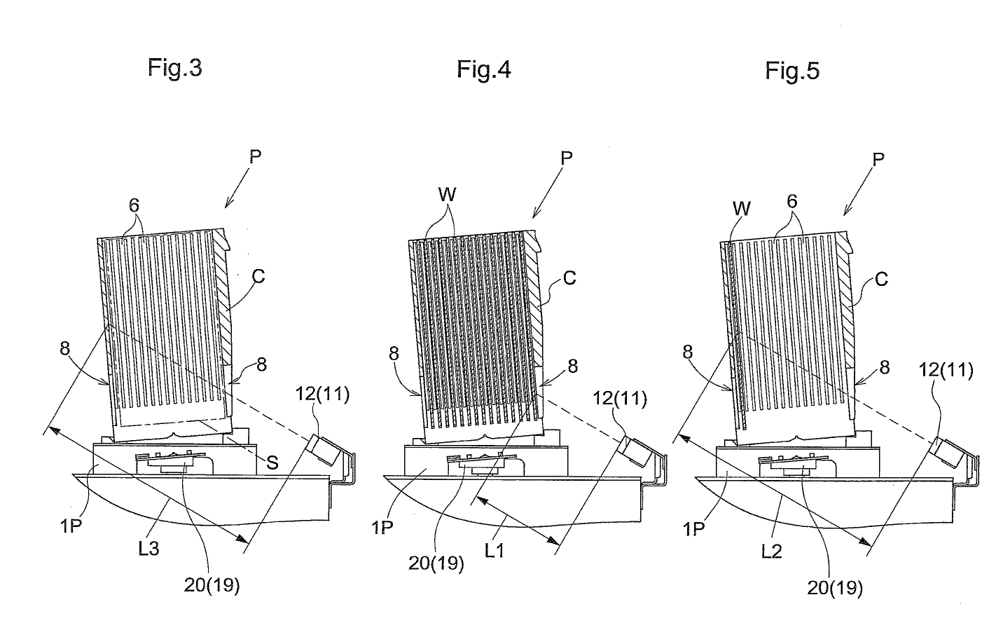

And as shown in FIG. 3, the range finder 12 emits laser light such that the laser light advances through the substrate storing area S in a direction that crosses, or intersects with, the direction along, or parallel to, the surface of a substrate W; thus, when a substrate W is stored in the substrate storing area S, the laser light is cast on the stored substrate W (or on the substrate W that is located on the most upstream side in the transport direction when two or more substrates are stored). In addition, since the range finder 12 emits laser light at an upward angle toward the downstream side in the transporting direction, the laser light emitted from the range finder 12 does not pass through the container C, and is cast on an inner surface of the container C even when there is no substrate W stored in the container C.

Thus, as shown in FIG. 4, in the full state in which all the slits 6 provided to the container C hold the substrates W, a value that corresponds to the distance L1 is detected, or registered, by the range finder 12. And, as shown in FIG. 5, when, among the slits 6 provided to the container C, only the slit 6 located on the most downstream side in the transport direction holds the substrate W, a value that corresponds to the distance L2 is detected, or registered, by the range finder 12. In addition, in the empty state in which no substrate W is stored in the container C, as shown in FIG. 3, a value that corresponds to the distance L3 is detected, or registered, by the range finder 12.

### [Controller]

A controller H which controls the operation of the transport device 1 and the in-storage transfer device 4 is provided to the substrate storage facility. And the detected values from the range finder 12 are input into this controller H. The controller H includes a presence determination portion h, implemented as a computer program or algorithm, for determining that a substrate W exists in the container C if and when a detected value from the range finder 12 falls within a predetermined range which is defined in advance as a range of the distance to the substrates W stored in the substrate storing area S of the container C that is located at the inspection location.

Defined as the predetermined range is a range that does not include the detected value that corresponds to the distance L3, and that is broader, by a tolerance range, than the range that spans from the detected value that corresponds to the distance L1 to the detected value that corresponds to the distance L2.

Thus, as shown in FIG. 4, when the container C is in the full state where all the slits 6 hold the substrates W and the detected value that corresponds to the distance L1 is detected by the range finder 12, the presence determination portion h determines that a substrate W exists in the container C because the detected value from the range finder 12 falls within the predetermined range.

Similarly, as shown in FIG. 5, when a substrate W is held only in the slit 6 of the container C that is on the most downstream side in the transporting direction and the detected value that corresponds to the distance L2 is detected by the range finder 12, the presence determination portion h determines that a substrate W exists in the container C because the detected value from the range finder 12 falls within the predetermined range.

And when the container C is in the empty state as shown in FIG. 3 and the detected value that corresponds to the distance L3 is detected by the range finder 12, then the presence determination portion h determines that no substrate W exists in the container C because the detected value from the range finder 12 does not fall within the predetermined range.

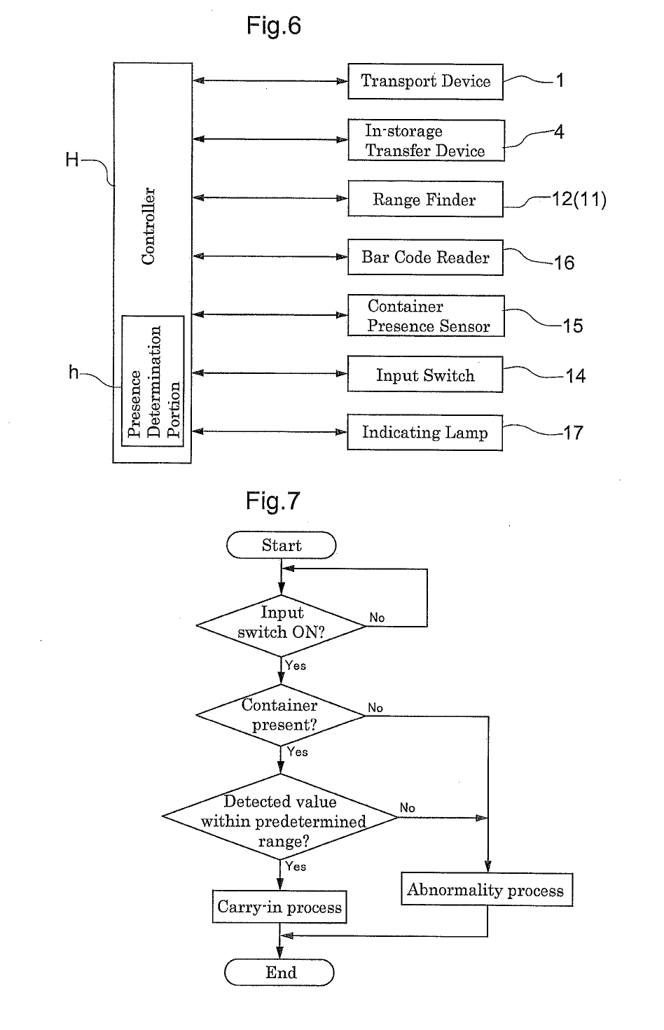

As shown in FIG. 6, the substrate storage facility is provided with an input switch 14 which a human worker pushes when a container C is placed on the inspection support platform 1P of the transport device 1 and is ready for storage in the stocker 3, a container presence sensor 15 for detecting whether a container C exists on the inspection support platform 1P, a bar code reader 16 for reading the bar code B attached to the container C located on the inspection support platform 1P, and an indicating lamp 17 for indicating an abnormal condition when it occurs. And an operation signal from the input switch 14, detected information from the container presence sensor 15, and detected information from the bar code reader 16 are input into the controller H, which is configured to control the operation of the indicating lamp 17 based on the detected information from the container presence sensor 15, and the detected information from the range finder 12.

The control sequence performed by the controller H when storing the container C in the stocker 3 is described next with reference to the flow chart in FIG. 7.

When the input switch 14 is operated by the human worker, it is determined whether a container C exists at the operator's transfer location P (inspection location) based on the detected information from the container presence sensor 15. And it is also determined whether a substrate W exists in the container C based on the detected value from the range finder 12.

And if it is determined that the container C exists at the operator's transfer location P (inspection location) and a substrate W exists in the container C, then the bar code reader 16 reads the bar code B; storage information which indicates, among other things, the storage position in the stocker 3 and the information specific to the container C are linked with each other and stored; and a carry-in process in which operations of the transport device 1 and the in-storage transfer device 4 are controlled is performed to store the container C in a storage section.

On the other hand, if it is determined that the container C does not exist at the operator's transfer location P (inspection location) or that no substrate W exists in the container C, then an abnormality process, in which the operation of the indicating lamp 17 is controlled in order to change its status to an abnormality indicating status, is performed.

When a container C that stores substrates W needs to be stored in the stocker 3, the human worker must place the container C, that stores the substrates W, at the operator's transfer location P. However, an empty container C which stores no substrate W is sometimes inadvertently placed at the operator's transfer location P. Even in such case, because the indicating lamp 17 is switched to a displaying state that indicates an abnormal condition, the human worker would notice that an empty container C is inadvertently placed at the operator's transfer location P. This would also prevent empty containers C from being stored in the stocker 3.

### Alternative Embodiments

(1) In the embodiment described above, the range finder 12 is so positioned that the detection wave is emitted in a direction that is tilted with respect to the substrate layering direction. However, the range finder 12 may be so positioned that the detection wave is emitted in a direction that is parallel to the substrate layering direction of the substrates W.

(2) In the embodiment described above, the transport device 1 is configured to receive and transport a container C in the tilted attitude in which the lower portions of the substrates W stored in the container C are displaced more toward the upstream side in the transport direction. However, the transport device 1 may be configured to receive and transport a container C in a tilted attitude in which the lower portions of the substrates W stored in the container C are displaced more toward the downstream side in the transport direction, or in a vertical attitude in which the substrates W stored in the container C are arranged along the vertical direction.

(3) In the embodiment described above, a range that includes all of the plurality of substrates W stored in the substrate storing area S is defined as the predetermined range. And it is determined that a substrate W exists in the container C if and when the detected value from the range finder 12 falls within the predetermined range. However, ranges each of which corresponds to each of the plurality of substrates W stored in the substrate storing area S may be defined as the predetermined ranges. And the facility may be configured such that if and when a detected value from the range finder 12 falls within a predetermined range, it is determined that a substrate W exists in a holding portion (slit 6) in the container C that corresponds to the range within which the detected value falls.

More specifically, for example, as shown in FIGS. 4 and 5, the facility may be configured such that it is determined that a substrate W exists in the holding portion on the most upstream side in the container C when a detected value that corresponds to the distance L1 is detected by the range finder 12 and that a substrate W exists in the holding portion on the most downstream side in the container C when a detected value that corresponds to the distance L2 is detected by the range finder 12.

(4) In the embodiment described above, the detecting portion 11 is a laser range finder 12. However, the detecting portion 11 may be any range finder such as an acoustic range finder 12.

In the embodiment described above, semiconductor wafers are stored in the containers C as the substrates W. However, other substrates, such as glass substrates may be stored in the containers C.

(5) In the embodiment described above, the carry-in process in which the operations of the transport device 1 and the in-storage transfer device 4 are controlled is performed in order to store a container C in a storage section when the presence determination portion h determines that a substrate W exists in the container C so that the containers C that hold substrates W are stored in the stocker 3. However, the carry-in process in which the operations of the transport device 1 and the in-storage transfer device 4 are controlled may be performed in order to store a container C in a storage section when the presence determination portion h determines that no substrate W exists in the container C so that the containers C that hold no substrates W are stored in the stocker 3.

What is claimed is:

1. A substrate detection apparatus for detecting a substrate within a container having a substrate storing area that can store a plurality of substrates in spaced-apart layers, the substrate detection apparatus comprising:
a detecting portion whose detection state changes depending on whether a substrate is present when a detection wave is emitted toward an opening formed in the container;
a transport device which supports and horizontally transports the container in a transporting attitude in which a substrate layering direction of the substrate storing area has a component in a transporting direction;
a presence determination portion which determines whether a substrate exists in the container;
wherein the detecting portion includes a range finder which receives the detection wave reflected by an object to detect a distance to the object,
wherein an inspection location is defined at an end of a moving range of the container as the container is transported by the transport device,
wherein the range finder is located outwardly of the end of the moving range in the transporting direction, and is configured to emit the detection wave toward the opening of the container located at the inspection location such that the detection wave advances through the substrate storing area in a direction that intersects with a direction that is parallel to a surface of a substrate; and
wherein the presence determination portion determines that a substrate exists in the container if and when a detected value from the range finder falls within a predetermined range defined as a range of distances to the substrates stored in the container located in the inspection location.

2. The substrate detection apparatus as defined in claim 1, wherein
the range finder is positioned such that the detection wave is emitted in a direction that is tilted with respect to the substrate layering direction.

3. The substrate detection apparatus as defined in claim 2, wherein
the transporting attitude is a tilted attitude in which lower portions of the substrates stored in the container are displaced more toward the end in the transport direction.

4. The substrate detection apparatus as defined in claim 1, wherein
the substrates are semiconductor wafers, and
wherein the range finder is a laser range finder which emits laser light and receives laser light that is reflected by an object to detect the distance to the object.
